(19) United States
(12) Patent Application Publication
(10) Pub. No.: US 2006/0208965 A1
(43) Pub. Date: Sep. 21, 2006

(54) Plasma display panel (PDP)

(76) Inventors: Byoung-Min Chun, Suwon-si (KR); Jeong-Nam Kim, Suwon-si (KR); Tae-Woo Kim, Suwon-si (KR); Jeong-Doo Yi, Suwon-si (KR)

Correspondence Address: ROBERT E. BUSHNELL, 1522 K STREET NW, SUITE 300, WASHINGTON, DC, 20005-1202, US

(21) Appl. No.: 11/297,349

(22) Filed: Dec. 9, 2005

(30) Foreign Application Priority Data
Mar. 15, 2005 (KR) 10-2005-0021370

(51) Int. Cl. G09G 3/28

(52) U.S. Cl. 345/60

(57) ABSTRACT

A Plasma Display Panel (PDP) easily extends each electrode terminal to terminal blocks of a front substrate or a rear substrate in a 4-electrode structure and includes: a first substrate and a second substrate facing each other; a barrier rib disposed between the first substrate and the second substrate, and partitioning discharge cells; a phosphor layer arranged in the discharge cell; a first electrode and a second electrode extending in one direction, corresponding to each discharge cell between the first substrate and the second substrate; a third electrode extending parallel to the first electrode and the second electrode, corresponding to the space between the first electrode and the second electrode; and an address electrode extending in the direction intersecting the third electrode and maintaining a space therebetween. The first electrode and the second electrode are extended to a terminal block of the second substrate, the address electrode is extended to a terminal block of the first substrate, and the third electrode is extended to the other terminal block of the first substrate.

### CLAIM OF PRIORITY

This application makes reference to, incorporates the same herein, and claims all benefits accruing under 35 U.S.C. §119 from an application for PLASMA DISPLAY PANEL earlier filled in the Korean Intellectual Property Office on 15 Mar. 2005 and there duly assigned Serial No. 10-2005-0021370.

### BACKGROUND OF THE INVENTION

1. Field of the Invention

The present invention relates to a Plasma Display Panel (PDP). More particularly, the present invention relates to a PDP providing easy extending of each electrode terminal to a terminal block of a front or rear substrate in a 4-electrode structure.

2. Description of the Related Art

Generally, a Plasma Display Panel (PDP) is fabricated by attaching a rear panel to a front panel and forming discharge cells filled with an inert gas therebetween. The PDP is operated by generating a gas discharge in the discharge cells.

That is, the rear panel has a rear substrate formed with address electrodes covered by a dielectric layer, a barrier rib formed on the dielectric layer, and phosphor layers formed on the barrier rib. The front panel facing the rear panel has a front substrate formed with display electrodes (sustain electrodes and scan electrodes formed in pairs) crossing the address electrodes. The display electrodes are covered by stacking a dielectric layer and a protective layer thereon.

The PDP displays an image by generating a plasma with a gas discharge in the discharge cells, generating vacuum ultraviolet (VUV) rays with the plasma, exciting a phosphor with the VUV rays, and generating red, green, or blue visible light from the phosphor.

A space in the PDP between the sustain electrode and the scan electrode is formed in a long gap to excite a wide area of the phosphor layer by radiating the VUV rays to the maximum range of the phosphor layer area formed in the discharge cell, and to improve brightness by increasing the amount of visible light generated therein.

However, if the space between the sustain electrode and the scan electrode is increased, a high sustain voltage must be supplied to the sustain electrode and the scan electrode to generate a sustain discharge between the two electrodes. As the sustain voltage is increased, the PDP may have a problem in that operating power consumption is increased.

Accordingly, the PDP must be designed to form the space between the sustain electrode and the scan electrode as a long gap in order to increase the brightness and to decrease the sustain voltage supplied to the sustain electrode and the scan electrode to reduce operating power consumption. For this purpose, a PDP having a sustain electrode and a scan electrode disposed in a long gap and further having an M-electrode between the two electrodes is being developed.

The PDP displays an image by selecting a turn-on discharge cell by generating the address discharge with a scan pulse supplied to the M-electrode and an address pulse supplied to the address electrode, and subsequently by generating a sustain discharge in the selected discharge cell with a sustain pulse reciprocally supplied to the sustain electrode and the scan electrode.

The above information disclosed in this section is only for enhancement of the understanding of the background of the invention and may contain information that is not prior art already known to a person in this country with ordinary skill in the art.

### SUMMARY OF THE INVENTION

The present invention has been made in an effort to provide a Plasma Display Panel (PDP) having an advantage of easy extending of each electrode terminal to terminal blocks of a front or rear substrate in a 4-electrode structure.

An exemplary PDP according to an embodiment of the present invention includes a first substrate and a second substrate facing each other, a barrier rib disposed between the first substrate and the second substrate, partitioning discharge cells, a phosphor layer formed in the discharge cells, a first electrode and a second electrode extending in one direction corresponding to each discharge cell between the first substrate and the second substrate, a third electrode extending parallel to the first electrode and the second electrode, corresponding to a space between the first and second electrodes and, and an address electrode disposed apart from the third electrode and extending in the direction crossing the third electrode. The first electrode and the second electrode are extended to a terminal block of the second substrate. The address electrode is extended to a terminal block of the first substrate. The third electrode is extended to another terminal block of the first substrate different from the terminal block to which the address electrode is extended.

The second substrate can face the first substrate such that the first substrate has terminal blocks formed on its three sides.

The first electrode and the second electrode can be formed on the second substrate, and can be extended to the same terminal block of the second substrate.

The third electrode can be formed on the first substrate, and can be extended to a terminal block of the first substrate opposite to the terminal block to which terminals of the first electrode and the second electrode are extended.

The address electrode can be formed on the first substrate maintaining a space with the third electrode, and can be extended in the vertical direction in which electrode terminals of the first electrode, second electrode, and third electrode are extended.

The second substrate can face the first substrate such that the first substrate has terminal blocks on its three sides. Two corners formed with the terminal blocks on the first substrate can be partially cut out, and the first substrate faces the second substrate so that the second substrate has terminal blocks at two corners thereof corresponding to the two cut-out corners of the first substrate.

The first electrode and the second electrode can be respectively extended to a different terminal block of the second substrate. The third electrode can be extended to a first substrate terminal block opposite to the terminal block to which the terminals of the first electrode are extended.

The terminals of the first electrode can be connected to a common terminal block of the second substrate, and the terminals of the second electrode can be connected to the other common terminal block of the second substrate.

Terminals of the second electrode can be connected to the terminal blocks of the second substrate at its two corners in common.

The address electrode can be extended in the vertical direction in which the electrode terminals of the first electrode and the third electrode are extended.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial exploded perspective view of a Plasma Display Panel (PDP) according to a first exemplary embodiment of the present invention.

FIG. 2 is a cross-sectional view of an assembled PDP, taken along the line II-II of FIG. 1.

FIG. 3 is a top plan view of an extending structure of electrode terminals in a PDP according to the first exemplary embodiment of the present invention.

FIG. 4 is a top plan view of an extending structure of electrode terminals in a PDP according to a second exemplary embodiment of the present invention.

### DETAILED DESCRIPTION OF THE INVENTION

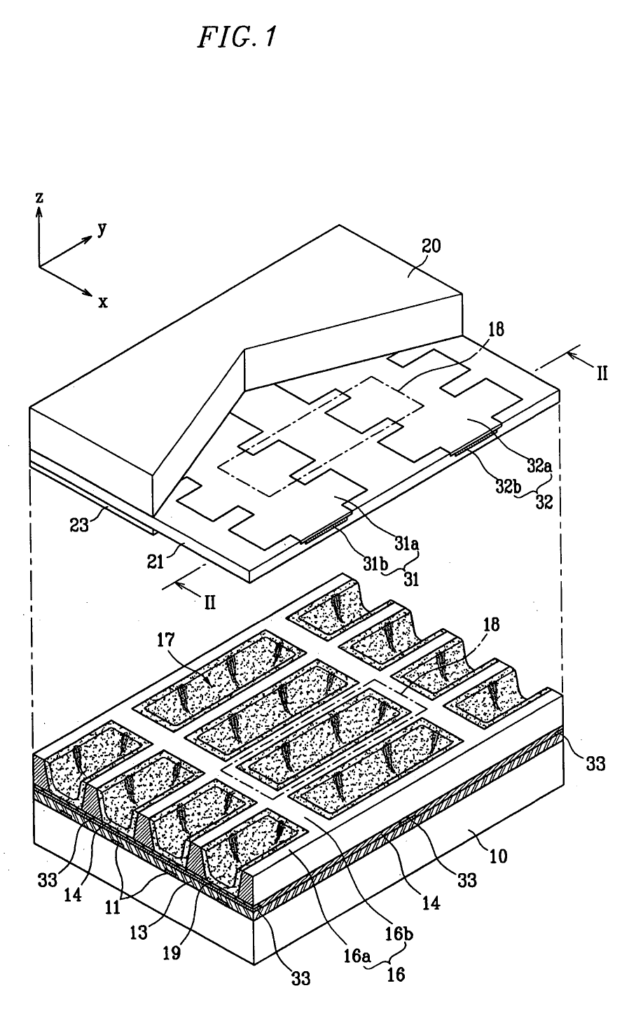

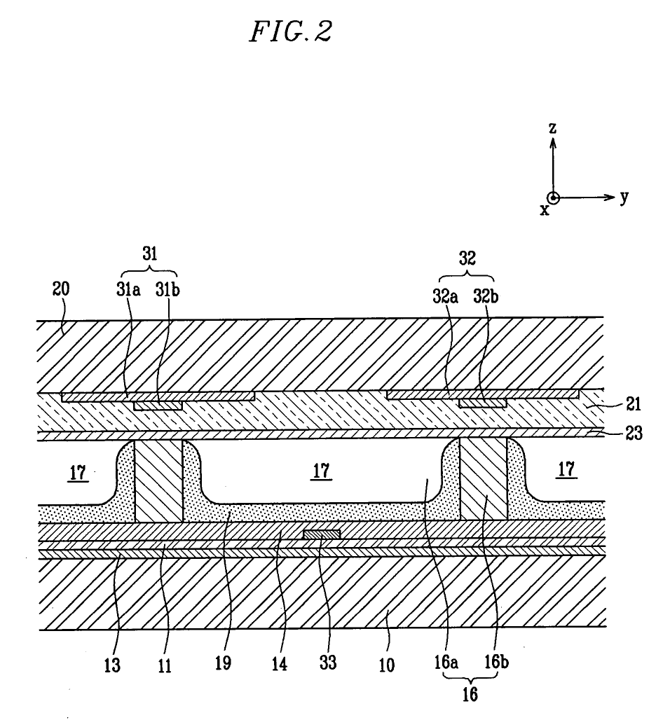

FIG. 1 is a partial exploded perspective view of a Plasma Display Panel (PDP) according to a first exemplary embodiment of the present invention, and FIG. 2 is a cross-sectional view of an assembled PDP, taken along the line II-II of FIG. 1.

The PDP includes a first substrate 10 (hereinafter referred to as a ‘rear substrate’) and a second substrate 20 (hereinafter referred to as a ‘front substrate’) facing each other and having a space therebetween, and a barrier rib 16 formed between the rear substrate 10 and the front substrate 20.

The barrier rib 16 forms discharge cells 18 by partitioning a plurality of discharge spaces 17 between the rear substrate 10 and the front substrate 20.

The discharge space 17 has a phosphor layer 19 which absorbs vacuum ultraviolet (VUV) rays and radiates visible light, and is filled with a discharge gas, for example, neon (Ne), xenon (Xe), or a mixture thereof, to generate vacuum ultraviolet (VUV) rays by a plasma discharge.

The PDP includes a first electrode 31 (hereinafter referred to as a ‘first sustain electrode’), a second electrode 32 (hereinafter referred to as a ‘second sustain electrode’), an address electrode I 1, and a third electrode 33 (hereinafter referred to as a ‘scan electrode’) corresponding to each discharge space 17, to display an image by radiating vacuum ultraviolet (VUV) rays generated by a plasma discharge to the phosphor layer 19.

The barrier rib 16 can be formed in a stripe shape by a first barrier rib member 16a formed in the elongated direction (y-axis direction) of the address electrode 1, or can be formed in a lattice shape by intersecting a second barrier rib member 16b formed in the x-axis direction with the first barrier rib member 16a, as shown in FIG. 1. The barrier rib 16 can form the discharge space 17 in a rectangular shape, or can form the discharge space 17 in various polygonal shapes including a hexagon and an octagon.

The address electrode 11 is formed lengthwise in the inner surface of the rear substrate 10 along the y-axis direction, continuously corresponding to the discharge spaces 17 adjacent thereto in the y-axis direction. Additionally, a plurality of address electrodes 11 are disposed in parallel with each other along the x-axis direction intersecting its lengthwise direction (y-axis direction), and maintaining a predetermined space corresponding to the discharge space 17.

As described above, the address electrodes 11 can be formed in the inner surface of the rear substrate 10, and covered by a first dielectric layer 13. The first dielectric layer 13 is formed of a dielectric material for generating and accumulating wall charges, and protects the address electrode 1 1 from damage by preventing a direct collision of positive ions or electrons with the address electrode 11 during discharge.

Additionally, the address electrode 11 can be formed of a metal having excellent electrical conductivity when the address electrode 11 is formed on a rear substrate 10 and blocks visible light.

The address electrodes 11 are formed lengthwise in the direction intersecting the scan electrode 33, corresponding to the discharge space 17, so that a discharge space 17 is addressed by an address pulse supplied to the address electrode 11 and a scan pulse supplied to the scan electrode 33. Additionally, the address electrodes 11 are apart from the scan electrode 33 in a direction vertical to both substrates 10 and 20 (i.e., in a z-axis direction shown in the drawing).

The scan electrode 33 is extended in the direction (x-axis direction) intersecting the address electrode 11, on the first dielectric layer 13 covering the address electrode 11. Additionally, the scan electrode 33 is covered by a second dielectric layer 14. A plurality of scan electrodes 33 can be disposed in parallel to each other, and maintaining a predetermined space with the discharge space 17 and corresponding thereto, along the y-axis direction intersecting the lengthwise direction (x-axis direction). The scan electrode 33 supplies a scan pulse during an address period, and supplies a reset pulse during a reset period.

The first dielectric layer 13 and the second dielectric layer 14 are formed between the address electrode 11 and the scan electrode 33. A space for discharge is not formed between the address electrode 11 and the scan electrode 33, and thus an address discharge is not generated even if the scan pulse is supplied to the scan electrode 33 and the address pulse is supplied to the address electrode 11. However, when the scan pulse and the address pulse are supplied, the discharge cell 18 forms a state different from that of other discharge cells to which the scan pulse and the address pulse are not supplied, and thus the discharge cell 18 can be selected as a turn-on discharge cell. Of course, if an additional discharge space (not shown) is formed between the address electrode 11 and the scan electrode 33, an address discharge can be generated by the scan pulse and the address pulse. The present invention includes all the structures described above.

Additionally, when the scan electrode 33 is formed on a rear substrate 10 and blocks visible light, the scan electrode 33 can be formed of a metal having excellent electrical conductivity like the address electrode 11.

The second dielectric layer 14 can be formed of the same dielectric material as that of the first dielectric layer 13, or can be formed of a different dielectric material. When the second dielectric layer 14 is provided, the phosphor layer 19 is formed by applying a phosphor to the inner surface of the barrier ribs 16 and to the surface of the second dielectric layer 14 surrounded by the barrier ribs 16.

The first sustain electrode 31 and the second sustain electrode 32 display an image by generating a sustain discharge with a sustain pulse supplied reciprocally in the discharge space 17 of the selected discharge cell 18. For this purpose, the first sustain electrode 31 and the second sustain electrode 32, having a barrier rib 16 therebetween, are formed in the inner surface of the front substrate 20, intersecting the address electrode 11. Additionally, the first sustain electrode 31 and the second sustain electrode 32 are respectively disposed over two discharge cells 18 adjacent in the elongated direction of the address electrode 11 (y-axis direction) such that each of the sustain electrodes 31 and 32 can be commonly shared by the adjacent discharge cells 18.

The first sustain electrode 31 and the second sustain electrode 32 can be respectively formed only with the bus electrodes 31b and 32b. However, transparent electrodes 31a and 32a are preferably formed together with the bus electrodes 31b and 32b.

The transparent electrodes 31a and 32a generate a surface discharge in the discharge space 17, and are formed with a transparent material such as Indium Tin Oxide (ITO) to secure a high aperture ratio. Bus electrodes 31b and 32b can be formed of metals, such as cobalt (Co) or silver (Ag), to secure electrical conductivity by compensating for the high electrical resistance of the transparent electrodes 31a and 32a.

The first sustain electrode 31 and the second sustain electrode 32 are preferably covered by a third dielectric layer 21. The third dielectric layer 21 protects the first sustain electrode 31 and the second sustain electrode 32 from the plasma discharge, and decreases the discharge firing voltage by forming and accumulating a wall charge during sustain discharge. The third dielectric layer 21 is preferably covered by a protective layer 23. The protective layer 23 is preferably formed with an MgO protective layer for transmitting visible light to increase transmissivity and to have a secondary electron emission coefficient.

The address electrode 11, scan electrode 33, first sustain electrode 31, and second sustain electrode 32 can act differently according to a signal voltage supplied thereto, and correlations between the electrodes and voltage signals are not limited to the correlations discussed above.

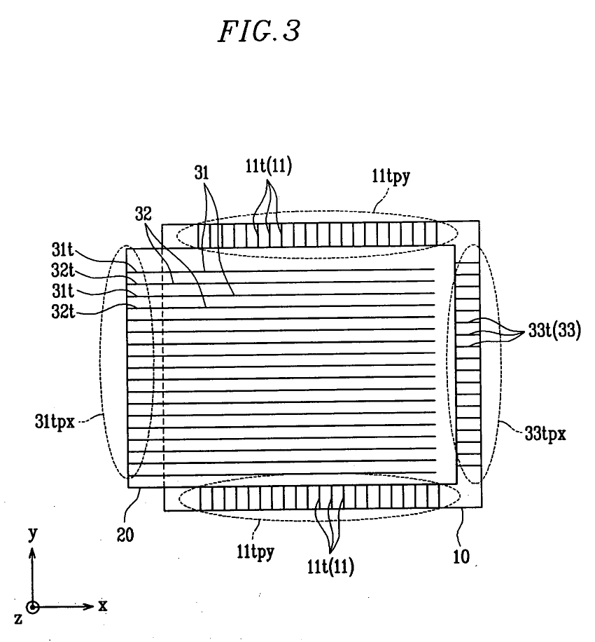

FIG. 3 is a top plan view of an extending structure of electrode terminals in a PDP according to the first exemplary embodiment of the present invention.

The address electrode 11, scan electrode 33, first sustain electrode 31, and second sustain electrode 32 are respectively extended to each terminal block formed at the edges of the rear substrate 10 or the front substrate 20 in order to supply a corresponding signal voltage, and each terminal block is respectively connected to each printed circuit board assembly (PBA, not shown).

The front substrate 20 and the rear substrate 10 face each other such that the rear substrate 10 can have each terminal block (11_{tpy} and 33ₜₚₓ) at its three sides. Additionally, the front substrate 20 can have a terminal block 31ₜₚₓ opposite to the terminal block 33ₜₚₓ of the rear substrate 10.

The address electrode 11 is extended to the y-axis direction on the rear substrate 10, and terminal 11ₜ of the address electrode 11 is extended to the terminal block 11_{tpy} formed at an edge of the rear substrate 10 in the y-axis direction. The terminal block 11_{tpy} can be formed at one edge in the y-axis direction, or can be formed at both edges in the y-axis direction as shown in FIG. 3. The terminal block 11_{tpy} can be formed at one side or at both sides according to the structure of the address electrode 11.

The terminal block 11_{tpy} of the address electrode 11 is connected to a printed circuit board assembly (PBA, not shown) formed in the y-axis direction on a chassis base (not shown) supporting the PDP.

The scan electrode 33 is extended in the x-axis direction intersecting the address electrode 11, maintaining a space with the address electrode 11 of the rear substrate 10. Accordingly, the terminal 33, of the scan electrode 33 is extended to the terminal block 33ₜₚₓ formed at an edge of the rear substrate 10 in the x-axis direction. As shown in FIG. 3, the terminal block 33ₜₚₓ is preferably formed at an edge of the rear substrate 10 in the x-axis direction.

The terminal block 33ₜₚₓ of the scan electrode 33 is connected to a printed circuit board assembly (PBA, not shown) formed at a side of the chassis base in the x-axis direction. Accordingly, the terminal block 33ₜₚₓ of the scan electrode 33 and the terminal block 11_{tpy} of the address electrode 11 can be connected to each printed circuit board assembly (PBA) without interfering with each other.

The first sustain electrode 31 and the second sustain electrode 32 are extended in the x-axis direction intersecting the address electrode 11 on the front substrate 20, and thereby the terminals 31ₜ and 32ₜ of the first sustain electrode 31 and the second sustain electrode 32 are extended to the terminal block 31ₜₚₓ formed at an edge of the front substrate 10 in the x-axis direction. The terminal block 31ₜₚₓ is preferably formed at an opposite edge of the terminal block 33ₜₚₓ of the scan electrode 33.

The terminal blocks 31ₜₚₓ of the first sustain electrode 31 and the second sustain electrode 32 are connected to a printed circuit board assembly (PBA, not shown) opposite to the printed circuit board assembly (PBA) connected to the terminal block 33ₜₚₓ of the scan electrode 33 on a chassis base (not shown) supporting the PDP. Accordingly, the terminal blocks 31ₜₚₓ of the first sustain electrode 31 and the second sustain electrode 32 can be connected to each printed circuit board assembly (PBA) so that the terminal block 33ₜₚₓ of the scan electrode 33 and the terminal block 11_{tpy} of the address electrode 11 do not interfere with each other.

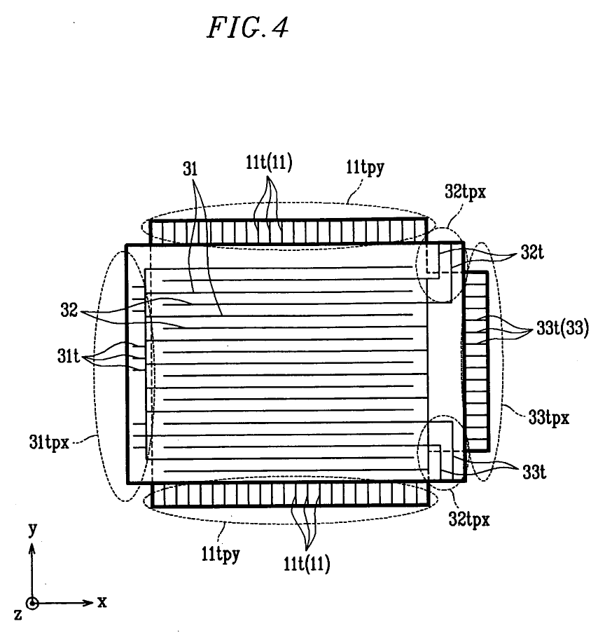

FIG. 4 is a top plan view of an extending structure of electrode terminals in a PDP according to a second exemplary embodiment of the present invention.

The structure and mechanism of the second exemplary embodiment are similar to or the same as those of the first exemplary embodiment. Accordingly, an explanation for the same configuration have been omitted, and different configurations will be described by comparing them.

In the first exemplary embodiment, the front substrate 20 faces the rear substrate 10 having each terminal block (1l_{tpy}, 33ₜₚₓ) at its three sides, and has the terminal block 31ₜₚₓ opposite to the terminal block 33ₜₚₓ of the rear substrate. However, in the second exemplary embodiment, two corners of the rear substrate 10 are cut out, and the front substrate 20 has the terminal blocks 32ₜₚₓ at each edge corresponding to the cut-out corners.

Accordingly, a first sustain electrode 31 and a second sustain electrode 32 are respectively extended to different terminal blocks 31ₜₚₓ and 32ₜₚₓ of the rear substrate 10.

In the second exemplary embodiment, the first sustain electrode 31 is extended to the terminal block 31ₜₚₓ, and the second sustain electrode 32 is extended to the terminal block 32ₜₚₓ opposite to the terminal block 31ₜₚₓ. Accordingly, the scan electrode 33 is extended to a terminal block 33ₜₚₓ opposite to the terminal block 31ₜₚₓ of the first sustain electrode 31.

A discharge cell 18 is selected by interaction of an address electrode 11 and a scan electrode 33, and an image is subsequently displayed by a sustain discharge of a first sustain electrode 31 and a second sustain electrode 32. Therefore, the same voltage signal is supplied to the first sustain electrodes 31 and the same voltage signal is supplied to the second sustain electrodes 32.

Accordingly, terminals 31ₜ of the first sustain electrode 31 can be connected to a terminal block 31ₜₚₓ of the front substrate 20 in common, and terminals 32ₜ of the second sustain electrode 32 can be connected to the other terminal block 32ₜₚₓ of the front substrate 20 in common. Additionally, the terminals 32ₜ of the second sustain electrode 32 can be extended to the same side, or extended to both sides as shown in FIG. 4. The same voltage signal can be supplied to the terminals 32ₜ even though the terminals 32ₜ are drawn out to both sides.

Additionally, since the terminals 32ₜ of the second sustain electrode 32 are connected in common, the terminal block 32ₜₚₓ of the second sustain electrode 32 can be connected to a printed circuit board assembly (PBA, not shown) formed in the y-axis direction on a chassis base (not shown) supporting the PDP, without interfering with the terminal block 33ₜₚₓ of the scan electrode 33.

That is, the address electrode 11 is extended in the y-axis direction perpendicular to the x-axis direction in which the electrode terminal 31ₜ of the first sustain electrode 31 and the electrode terminals 33t of the scan electrode 33 are extended.

As described above, a PDP according to an embodiment of the present invention includes a first sustain electrode and a second sustain electrode formed on a front substrate, an address electrode formed on a rear substrate in a direction crossing the first sustain electrode and the second sustain electrode, and a scan electrode formed above an address electrode of the rear substrate maintaining the space therebetween and intersecting each other. In such a PDP, addressing is performed by interaction between the address electrode and the scan electrode, and a sustain discharge is performed by interaction between the first sustain electrode and the second sustain electrode. In this scheme, non-transparent bus electrodes of a first sustain electrode and a second sustain electrode are located on a barrier rib, and luminescence efficiency is thereby improved by preventing visible light from being blocked by bus electrodes of the first sustain electrode and the second sustain electrode.

Additionally, an exemplary embodiment according to the present invention provides an advantage that extending of each electrode terminal can be performed easily by extending the first sustain electrode and the second sustain electrode formed on the front substrate to a terminal block of the front substrate, extending the address electrode formed on the rear substrate to a terminal block of the rear substrate, and extending the scan electrode formed on the address electrode to another terminal block of the rear substrate.

While exemplary embodiments of the present invention have hereinbefore been described, it should be understood that the present invention is not limited to the disclosed embodiments and the accompanying drawings, but rather various changes and modifications thereof are possible without departing from the spirit and scope of the appended claims.

What is claimed is:

1. A plasma display panel, comprising:
a first substrate and a second substrate facing each other;
a barrier rib arranged between the first substrate and the second substrate and adapted to partition discharge cells;
a phosphor layer formed in each discharge cell;
a first electrode and a second electrode extending in one direction, corresponding to the discharge cells between the first substrate and the second substrate;
a third electrode extending parallel to the first and second electrodes, corresponding to a space between the first and second electrodes; and
an address electrode disposed apart from the third electrode and extending in a direction crossing the third electrode;
wherein the first electrode and the second electrode are extended to a terminal block of the second substrate;
wherein the address electrode is extended to a terminal block of the first substrate; and
wherein the third electrode is extended to another terminal block of the first substrate different from the terminal block to which the address electrode is extended.

2. The plasma display panel of claim 1, wherein the second substrate faces the first substrate such that the first substrate has terminal blocks at its three sides.

3. The plasma display panel of claim 2, wherein the first electrode and the second electrode are arranged on the second substrate.

4. The plasma display panel of claim 3, wherein the first electrode and the second electrode are extended to the same terminal block of the second substrate.

5. The plasma display panel of claim 4, wherein the third electrode is arranged on the first substrate.

6. The plasma display panel of claim 5, wherein the third electrode is extended to the first substrate terminal block opposite to the terminal block to which terminals of the first electrode and the second electrode are extended.

7. The plasma display panel of claim 6, wherein the address electrode is arranged on the first substrate and maintains a space with the third electrode.

8. The plasma display panel of claim 7, wherein the address electrode is extended to a terminal block of the first substrate in the direction perpendicular to the direction in which electrode terminals of the first electrode, second electrode, and third electrode are extended.

9. The plasma display panel of claim 7, wherein the address electrode is extended to both terminal blocks of the first substrate in the direction perpendicular to the direction in which electrode terminals of the first electrode, second electrode, and third electrode are extended.

10. The plasma display panel of claim 2, wherein two corners defined by the terminal blocks on the first substrate are partially cut out, and wherein the first substrate faces the second substrate so that the second substrate has terminal blocks at two corners thereof corresponding to the two cut-out corners of the first substrate.

11. The plasma display panel of claim 10, wherein the first electrode and the second electrode are arranged on the second substrate.

12. The plasma display panel of claim 11, wherein the first electrode and the second electrode respectively extend to a different terminal block of the second substrate.

13. The plasma display panel of claim 12, wherein the third electrode is arranged on the first substrate.

14. The plasma display panel of claim 13, wherein the third electrode is extended to a first substrate terminal block opposite to the terminal block to which the terminals of the first electrode are extended.

15. The plasma display panel of claim 14, wherein the terminals of the first electrode are connected to a common terminal block of the second substrate and the terminals of the second electrode are connected to the other common terminal block of the second substrate.

16. The plasma display panel of claim 15, wherein the terminals of the second electrode are connected to the terminal blocks of the second substrate at its two corners in common.

17. The plasma display panel of claim 16, wherein the address electrode is arranged on the first substrate and maintains a space with the third electrode.

18. The plasma display panel of claim 17, wherein the address electrode is extended to a terminal block of the first substrate in the direction perpendicular to the direction in which electrode terminals of the first electrode and the third electrode are extended.

19. The plasma display panel of claim 17, wherein the address electrode is extended to a terminal block of the first substrate in the direction perpendicular to the direction in which electrode terminals of the first electrode and the third electrode are extended.
